(19) United States
(12) Patent Application Publication
(10) Pub. No.: US 2026/0323243 A1
(43) Pub. Date: Oct. 15, 2026

(54) METHODS AND APPARATUSES FOR MANAGING GROUND TRUTH LABEL ACQUISITION FOR ARTIFICIAL INTELLIGENCE/MACHINE LEARNING BASED POSITIONING IN A WIRELESS NETWORK

(71) Applicants: Centre of Excellence in Wireless Technology, Chennai (IN); Indian Institute of Technology Madras (IIT Madras), Chennai (IN)

(72) Inventors: Jishnu Ponnappan, Chennai (IN); Abhijeet Abhimanyu Masal, Chennai (IN); Anusuya Balasubramanian, Chennai (IN); Jeniston Deviraj Klutto Milleth, Chennai (IN); Bhaskar Ramamurthi, Chennai (IN); Vikram Krishnakumar, Chennai (IN); Aswathy Subramaniam, Chennai (IN)

(21) Appl. No.: 19/533,020

(22) Filed: Feb. 6, 2026

(30) Foreign Application Priority Data
Feb. 6, 2025 (IN) 202541010118

(51) Int. Cl. H04W 4/029; H04W 24/08

(52) U.S. Cl. CPC H04W 4/029; H04W 24/08

(57) ABSTRACT

A method for subscription-based GTL acquisition and AI/ML model training at an NG-RAN node is disclosed. The method for collecting GTL of UE by next generation random access network (NG-RAN) node to train and monitor AI/ML model used for user equipment (UE) positioning, comprises sending, by the NG-RAN to an access and mobility management function (AMF), a subscription request to obtain a ground truth label (GTL) associated with at least one UE connected to the NG-RAN node, obtaining, by the NG-RAN, at least one radio signal measurement from a target UE during a positioning session associated with a location service (LCS) request, receiving, by the NG-RAN, from a location management function (LMF), the GTL corresponding to the target UE based on the AMF indication to the LMF to share the GTL with the NG-RAN and training, by the NG-RAN, the AI/ML model for UE positioning by using at least one of the GTL and at least one radio signal measurement.

### FIELD OF THE INVENTION

The present disclosure relates generally to wireless communications and, more particularly, to systems and methods for training artificial intelligence (AI) and machine learning (ML) positioning models within a Radio Access Network (RAN). Specifically, the disclosure relates to signaling mechanisms between a base station (e.g., a gNB or next generation random access network (NG-RAN) node, an Access and Mobility Management Function (AMF), and a Location Management Function (LMF) for managing Ground Truth Label (GTL) subscriptions, facilitating requirement-based data collection, and verifying user consent during the AI/ML model training process.

### BACKGROUND OF THE INVENTION

The integration of AI/ML and the related use cases have seen tremendous progress in the advanced stages of the 5^{th} generation (5G) wireless communication and is expected to be an important research area in the ensuing 6^{th} generation (6G) communication technology.

Positioning is one of the vital features in 5G/6G mobile communication technology due to its wide range of business applications. Emergency call positioning is emerging as an important use case due to regulatory requirements from the Federal Communications Commission (FCC). Many other critical services rely on positioning as well, with much more stringent requirements on accuracy, time to first fix, and latency. Further, various commercial applications and use cases are coming up with more stringent positioning requirements in 5G and beyond systems.

Studies are ongoing to explore the benefits of augmenting the air interface with features enabling improved support for AI/ML. The 3rd Generation Partnership Project (3GPP) framework for AI/ML is studied for air interfaces corresponding to each target use case regarding aspects such as performance, complexity, and potential specification impact. The positioning of a User Equipment (UE) is one such feature where AI/ML is being enabled using the radio access network (RAN). AI/ML support for positioning is expected to help achieve more accurate positioning.

Despite the potential of AI/ML, several technical challenges remain in its practical deployment for positioning namely the following: Ground Truth Acquisition: AI/ML models require high-accuracy “Ground Truth Labels” (GTLs) for effective training, which act as the reference location for the model to learn from radio signal patterns, signaling Overhead: Current frameworks lack efficient mechanisms for the NG-RAN to dynamically subscribe to these labels or negotiate their delivery based on real-time model needs, leading to potential signaling congestion, model drift and retraining: Radio environments are dynamic however, existing systems do not adequately provide a closed-loop mechanism to monitor model performance and proactively trigger retraining cycles and privacy and coordination: Obtaining GTLs often requires coordination between the RAN and core network functions like the Access and Mobility Management Function (AMF) and Location Management Function (LMF), specifically regarding user consent and subscription management.

Consequently, there is a need for a streamlined architecture and method that facilitates the automated subscription, requirement negotiation, and proactive training of AI/ML models to maintain high positioning accuracy in dynamic 5G and beyond environments.

### SUMMARY OF THE INVENTION

The summary is provided to introduce embodiments related to methods of wireless communication, and the embodiments are further described below in the detailed description. This summary is not intended to identify essential features of the claimed subject matter nor is it intended for use in determining or limiting the scope of the claimed subject matter.

A method for subscription-based GTL acquisition and AI/ML model training at an NG-RAN node is disclosed in accordance with an embodiment of the present disclosure. The method for collecting GTL of UE by next generation random access network (NG-RAN) node to train and monitor AI/ML model used for UE positioning, comprises sending, by the NG-RAN to an AMF, a subscription request to obtain a GTL associated with at least one UE connected to the NG-RAN node, obtaining, by the NG-RAN, at least one radio signal measurement from a target UE during a positioning session associated with a location service (LCS) request, receiving, by the NG-RAN, from a LMF, the GTL corresponding to the target UE based on the AMF indication to the LMF to share the GTL with the NG-RAN and training, by the NG-RAN, the AI/ML model for UE positioning by using at least one of the GTL and at least one radio signal measurement.

A method for requirement-based GTL acquisition at an NG-RAN node during an ongoing positioning session is disclosed in accordance with another embodiment of the present disclosure. The method for collecting GTL of UE by a NG-RAN node to train and monitor AI/ML model used for UE positioning, comprises identifying, by a NG-RAN, a positioning session associated with a LCS request for a target UE, obtaining, by the NG-RAN, at least one radio signal measurement from a target UE during a positioning session associated with a LCS request, sending 1406, by the NG-RAN to LMF, an indication of a requirement status for a GTL to train an AI/ML model for the target UE, receiving, 1408 by the NG-RAN from the LMF, the GTL, based on the indication of the requirement status and training 1410, by the NG-RAN, the AI/ML model using at least one of the GTL and the at least one radio signal measurement obtained during the ongoing positioning session.

A method for GTL requirement negotiation and delivery from the perspective of an LMF is disclosed in accordance with another embodiment of the present disclosure. The method for sending GTL of UE by a LMF to a NG-RAN, comprises determining, by the LMF, requirement of a GTL by a NG-RAN, receiving, by the LMF from the NG-RAN, an indication of a requirement of the GTL in response to the query, generating, by the LMF, the GTL using the location estimate of the target UE and sending, by the LMF to the NG-RAN, the GTL.

A method for proactive AI/ML model training based on performance monitoring and user consent verification is further disclosed in accordance with another embodiment of the present disclosure. The method for collecting GTL of UE by NG-RAN node to train and monitor AI/ML model used for UE positioning, comprises initiating, by a NG-RAN, at least one of a AI/ML model training and a AI/ML model monitoring based on a performance output of an AI/ML model monitoring unit, selecting, by the NG-RAN, plurality of UEs associated with the NG-RAN node targeted for AI/ML training and monitoring, sending, by the NG-RAN to an AMF, a request for a GTL, receiving, by the NG-RAN from the LMF selected by the AMF, a GTL for each UE with the consent from a plurality of UEs based on the AMF indication to the LMF to share the GTL with the NG-RAN.

Embodiments of the present disclosure features of a wireless communication system configured to perform the methods described herein. The base station (BS) comprises a processor, a transmit/receive unit coupled to one or more antennas, and a memory. The memory may store instructions that, when executed by the processor, cause the BS to perform its designated functions. The transmit/receive unit is configured to transmit downlink signals and receive uplink signals from the UE.

The UE comprises a processor, a transmit/receive unit coupled to one or more antennas, and a memory. The memory may store instructions that, when executed by the processor, cause the UE to perform all the UE-side steps of the methods described herein. In various embodiments of the present disclosure, the components of the system are configured to operate in conjunction to perform the methods for UE positioning. Specifically, in an embodiment, the processor of the UE is configured to send, by the NG-RAN to an AMF, a subscription request to obtain a GTL associated with at least one UE connected to the NG-RAN node, obtain, by the NG-RAN, at least one radio signal measurement from a target UE during a positioning session associated with a LCS request, receive, by the NG-RAN, from a LMF, the GTL corresponding to the target UE based on the AMF indication to the LMF to share the GTL with the NG-RAN and train, by the NG-RAN, the AI/ML model for UE positioning by using at least one of the GTL and at least one radio signal measurement.

In another embodiment, the processor of the UE is configured to identify, by a NG-RAN, a positioning session associated with a LCS request for a target UE, obtain, by the NG-RAN, at least one radio signal measurement from a target UE during a positioning session associated with a LCS request, send, by the NG-RAN to a LMF, an indication of a requirement status for a GTL to train an AI/ML model for the target UE, receive, by the NG-RAN from the LMF, the GTL, based on the indication of the requirement status and train, by the NG-RAN, the AI/ML model using at least one of the GTL and the at least one radio signal measurement obtained during the ongoing positioning session.

In another embodiment, the processor of the UE is configured to determine, by the LMF, requirement of a GTL by a NG-RAN, receive, by the LMF from the NG-RAN, an indication of a requirement of the GTL in response to the query, generate, by the LMF, the GTL using the location estimate of the target UE; and send, by the LMF to the NG-RAN, the GTL.

In yet another embodiment, the processor of the UE is configured to initiate, by a NG-RAN, at least one of a AI/ML model training and a AI/ML model monitoring based on a performance output of an AI/ML model monitoring unit, select, by the NG-RAN, plurality of UEs associated with the NG-RAN node targeted for AI/ML training and monitoring, send, by the NG-RAN to an AMF, a request for a GTL, receive, by the NG-RAN from the LMF selected by the AMF, a GTL for each UE with the consent from a plurality of UEs based on the AMF indication to the LMF to share the GTL with the NG-RAN.

The above summary is provided merely for the purpose of summarizing some example embodiments to provide a basic understanding of some embodiments of the present disclosure. Accordingly, as previously noted, the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, embodiments, and advantages of the subject will become apparent from the description, the drawings, and the claims.

### BRIEF DESCRIPTION OF THE DRAWINGS

The accompanying drawings are included to provide a further understanding of the present disclosure, and are incorporated in and constitute a part of this specification.

FIG. 1 illustrates a functional framework for GTL acquisition and AI/ML model training within a 5G network;

FIG. 2 is a schematic representation of a positioning network architecture in accordance with the present disclosure;

FIG. 3 illustrates methods of obtaining the GTL from the LMF in accordance with embodiments of the present disclosure;

FIG. 4 illustrates a subscription-based implicit method for obtaining GTL from the LMF in accordance with an embodiment of the present disclosure;

FIG. 5 illustrates a NG-RAN-initiated runtime-based implicit method for obtaining the GTL from the LMF in accordance with an embodiment of the present disclosure;

FIG. 6 illustrates a LMF-initiated runtime-based implicit method requesting the NG-RAN for the GTL requirement during an active positioning session in accordance with an embodiment of the present disclosure;

FIG. 7 illustrates a LMF-initiated runtime-based implicit method requesting the NG-RAN for the GTL requirement after an active positioning session according to an embodiment of the present disclosure;

FIG. 8 illustrates a LMF-initiated runtime-based implicit method to send the GTL in an unsolicited manner to the NG-RAN according to an embodiment of the present disclosure;

FIG. 9 illustrates an explicit method to obtain the GTL from the LMF using a Next Generation Application Protocol (NGAP) message containing list of UE(s) in accordance with an embodiment of the present disclosure;

FIG. 10 illustrates an explicit method to obtain the GTL from the LMF using the NGAP message without list of UE(s) in accordance with an embodiment of the present disclosure;

FIG. 11 illustrates an explicit method to obtain the GTL from the LMF using the New Radio Positioning Protocol A (NRPPa) PDU containing list of UE(s) in accordance with an embodiment of the present disclosure;

FIG. 12 illustrates an explicit method to obtain the GTL from the LMF using the NRPPa PDU without list of UE(s) in accordance with an embodiment of the present disclosure;

FIG. 13 is a flowchart illustrating a method for subscription-based GTL acquisition and AI/ML model training at an NG-RAN node in accordance with an embodiment of the present disclosure;

FIG. 14 is a flowchart illustrating a method for requirement-based GTL acquisition at an NG-RAN node during an ongoing positioning session in accordance with another embodiment of the present disclosure;

FIG. 15 is a flowchart illustrating a method for GTL requirement negotiation and delivery from the perspective of a LMF in accordance with another embodiment of the present disclosure;

FIG. 16 is a flowchart illustrating a method for proactive AI/ML model training based on performance monitoring and user consent verification in accordance with another embodiment of the present disclosure;

FIG. 17 illustrates an example communication system configured to implement AI/ML-assisted positioning methods described in the present disclosure;

FIG. 18 is an example wireless communication system configured to perform the methods described in FIGS. 4-16 of the present disclosure.

### DETAILED DESCRIPTION OF THE INVENTION

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. This disclosure may however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

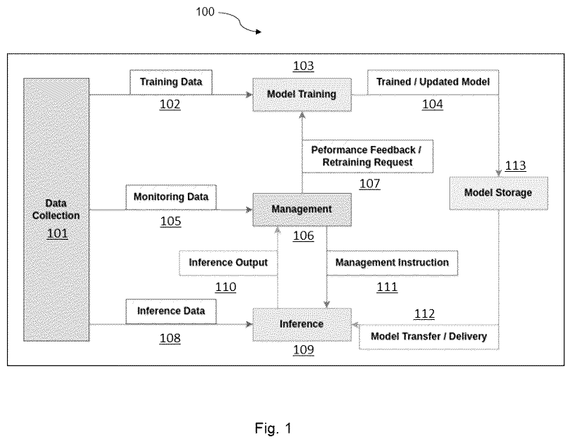

FIG. 1 illustrates a functional framework 100 for GTL acquisition and AI/ML model training within a 5G network. Data collection is a function that provides input data to the Model Training, Management, and Inference functions. Model Training is a function that performs AI/ML model training, validation, and testing which may generate model performance metrics which can be used as part of the model testing procedure.

The Model Training function 103 is also responsible for data preparation (e.g., data pre-processing and cleaning, formatting, and transformation) based on Training Data 102 delivered by a Data Collection function 101, if required. Management 106 is a function that oversees the operation (e.g., selection/(de) activation/switching/fallback) and monitoring 105 (e.g., performance) of AI/ML models or AI/ML functionalities. This function is also responsible for making decisions to ensure the proper inference operation based on data received from the Data Collection function and the Inference function.

Inference 109 is a function that provides outputs 110 from the process of applying AI/ML models or AI/ML functionalities, using the data that is provided by the Data Collection function (i.e., Inference Data) as an input. The Inference function is also responsible for data preparation (e.g., data pre-processing and cleaning, formatting, and transformation) based on Inference Data 108 delivered by a Data Collection function, if required. Model Storage 113 is a function responsible for storing trained/updated models 104 that can be used to perform the Inference function.

The application of AI/ML in positioning along with accuracy enhancement is divided into two categories viz., direct AI/ML positioning and AI/ML-assisted positioning. In direct AI/ML positioning, the output of the AI/ML model is the location of the UE. For example, fingerprinting based on channel observation as the input of AI/ML model. In the case of AI/ML-assisted positioning, the output of the AI/ML model is a new measurement and/or enhancement of the existing measurement. Line of sight (LoS)/Non-line of sight (NLoS) identification, timing and/or angle of measurement, and likelihood of measurement are some of the examples.

The AI/ML model(s) may be located at the UE-side, the LMF-side or the gNB-side. Similarly, the positioning computation may be performed either as UE-based, gNB-based, or LMF-based. The LMF-based computation may be either UE-assisted or next generation random access network (NG-RAN) node-assisted. Based on the above criteria, the positioning enhancement use cases are tabulated in the table 1 below:

TABLE 1
Positioning Accuracy Enhancement Use Cases

| | | AI/ML | AI/ML | Positioning |
|---|---|---|---|---|
| | Positioning | Inference | Positioning | Methods |
| Scenario | Computation | Location | Type | Supported |
| 1 | UE-based | UE-side | Direct | AI/ML |
| | | | | Methods |
| 2a | UE- | UE-side | Assisted | DL-TDOA, |
| | assisted/ | | | DL-AoD, |
| | LMF-based | | | Multi-RTT, |
| | | | | NR E-CID |
| 2b | UE- | LMF-side | Direct | AI/ML |
| | assisted/ | | | Methods |
| | LMF-based | | | |
| 3a | NG-RAN node | gNB-side | Assisted | Multi-RTT, |
| | assisted | | | NR E-CID, |
| | | | | UL-TDOA, |
| | | | | UL-AoA |
| 3b | NG-RAN node | LMF-side | Direct | AI/ML |
| | assisted | | | Methods |

As indicated in Table 1, for the direct AI/ML approach, the inference location can be either UE-sided or LMF-sided. For UE-sided inference, the positioning computation is UE-based whereas for LMF-sided inference, the positioning computation is UE-assisted or NG-RAN-assisted which can be called LMF-based. Similarly, for the AI/ML-assisted approach, the inference location can be at the UE side, the LMF side, or the gNB side. In UE-sided inference, the positioning computation is UE-assisted/LMF-based, while for the gNB-sided inference, the positioning computation is NG-RAN node-assisted. For LMF-sided inference, the positioning computation can be either UE-assisted/LMF-based or NG-RAN node-assisted.

The present disclosure provides describes scenario 3a in detail where NG-RAN based AI/ML model is used to infer the positioning measurements like time of arrival (ToA), angle of arrival (AoA) etc. The measurements are forwarded to LMF for estimation of UE location using the measurements.

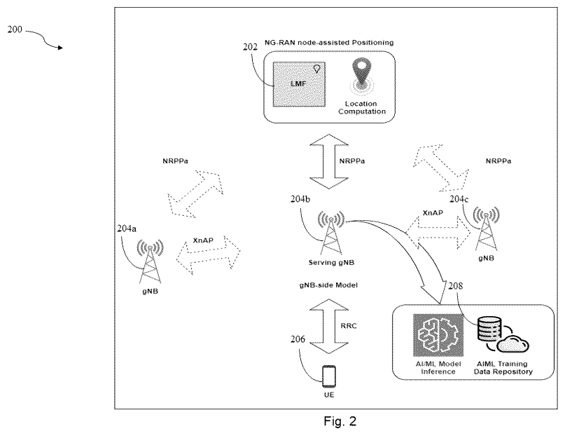

FIG. 2 is a schematic representation of a positioning network architecture 200 in accordance with the present disclosure. The AI/ML positioning scenario 3a as illustrated in FIG. 2, is classified as an AI/ML-assisted positioning method where the AI/ML inference at the serving gNB 204b predicts the positioning measurements such as ToA, angle of arrival AoA, carrier phase, etc. These measurements are provided to a LMF 202 for positioning computation of the UE 206. The training, monitoring, and storage aspects of the gNB-side model are handled at the gNB or the operations and management entity (OAM) associated with the gNB.

For the inference phase, the existing new radio positioning protocol (NRPPa) signaling is sufficient to perform the AI/ML-assisted positioning. However, for training the AI/ML model, there are some modifications/additions required from the signaling perspective, which will be discussed in the following sections.

The architecture 200 provides a distributed framework for coordinated AI/ML-assisted positioning, particularly focusing on the interaction between the Radio Access Network (RAN) and core network functions for model training.

As illustrated in FIG. 2, architecture 200 includes the LMF 202, which acts as a core network entity responsible for location computation. In the context of the present disclosure, the LMF 202 is configured to generate GTLs based on high-accuracy location estimates computed during positioning sessions.

The architecture 200 further comprises a plurality of base stations, shown as gNBs 204a, 204b, and 204c. A Serving gNB 204b is communicatively coupled to UE 206 via a radio interface using Radio Resource Control (RRC) signaling. The Serving gNB 204b hosts a gNB-side model and an AI/ML Training Data Repository 208. This repository is configured to aggregate and pair radio signal measurements received from the UE 206 with GTLs received from the LMF 202.

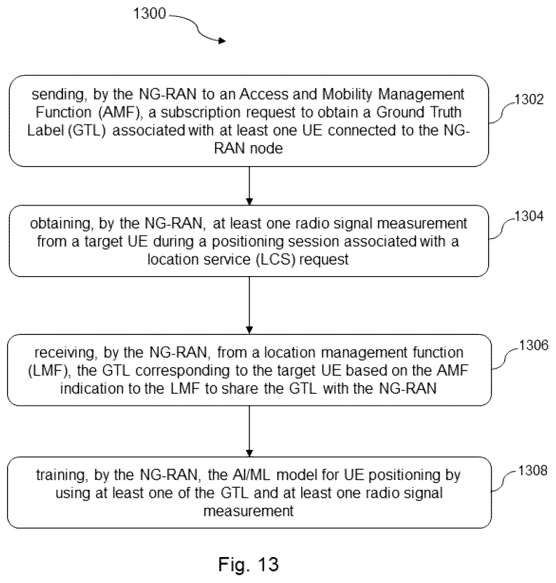

To facilitate multi-cell data collection, the Serving gNB 204b is interconnected with Neighboring gNBs 204a and 204c via an XnAP interface. This interface allows the Serving gNB 204b to request and receive auxiliary radio measurements from neighboring cells to enhance the accuracy and robustness of the training dataset stored in the AI/ML Training Data Repository. Communication between the LMF 202 and the gNB layer (e.g., Serving gNB 204b) is conducted over a NRPPa interface. The NRPPa interface is utilized for transmitting GTL requirement status queries from the LMF 202 to the Serving gNB 204b, delivering computed GTLs from the LMF 202 to the Serving gNB 204b for storage in the training repository and exchanging acknowledgments (ACK/NACK) regarding the successful reception and pairing of GTL data, which will be described in more detail in FIGS. 13-16.

By distributing the AI/ML Model Inference and Data Repository at the Serving gNB 204b, the architecture 200 enables proactive, low-latency model updates based on real-time network conditions and high-fidelity ground truth provided by the core network.

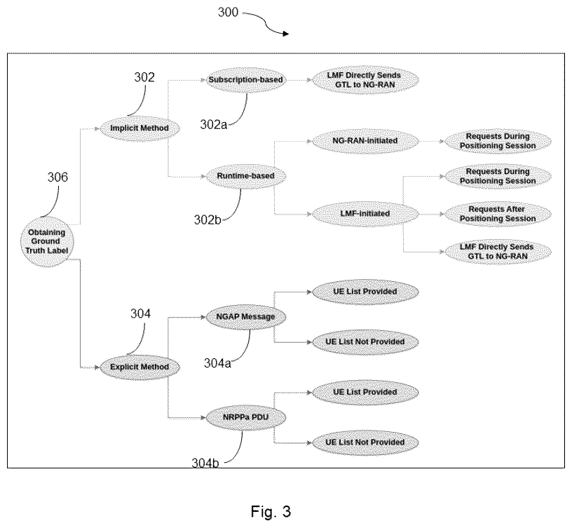

FIG. 3 illustrates methods 302, 304 of obtaining the GTL 306 from the LMF in accordance with embodiments of the present disclosure. For training supervised AI/ML models, there is a need for the GTL which sets the benchmark for calibrating the model accurately (necessary in case of supervised learning of the AI/ML model). Further this label may be used for model monitoring purposes as well. In the case of AI/ML positioning, this label is the location information (absolute/relative) and is provided by the LMF. Hence, for the gNB-side model, the gNB must obtain the GTL from the LMF before starting the data collection and model training procedures. This disclosure proposes methods by which the gNB can obtain the GTL from the LMF as shown in FIG. 3.

The GTL can be acquired using two ways-implicit 302 and explicit methods 304. The process of training the AI/ML model at the cell tower (gNB) requires GTL i.e. the verified location of a device, to calibrate its predictions. There are two primary ways the gNB can obtain this label, namely the implicit and explicit methods. In the implicit method, the gNB can take advantage of the ongoing positioning session to get the GTL whenever it is involved, whereas in the explicit method, the gNB itself initiates the positioning procedure to get the GTL. The LMF sends the GTL to the gNB at the end of the location computation of the UE. The implicit method involves data collection from a UE which is already part of a positioning session while the explicit method may need the involvement of a specific list of UE(s), or any random list of UE(s) associated with the gNB. Hence, there may be a requirement for obtaining the consent of the UE(s) chosen for the data collection procedure in the explicit method. The AMF is responsible for addressing the consent-related aspects.

The implicit method is dependent on the occurrence of the positioning session from location service (LCS) request for a UE connected with the gNB of interest. The implicit method can be further divided into two categories-subscription-based 302a and runtime-based 302b. The subscription-based approach 302a is where the gNB registers for GTL subscription at the AMF so that whenever there is an ongoing positioning session involving the gNB (e.g. the target UE in the positioning session is associated with the gNB subscribing the data), the location results are shared with the gNB by the LMF. The gNB keeps getting the GTL from the LMF as long as the subscription is active. The gNB sends a cancellation request to stop the GTL subscription once the model training is not required. The AMF/LMF can also terminate the subscription based on the relevant policies.

The runtime-based method 302b can be initiated by either the NG-RAN or the LMF. The NG-RAN can initiate a GTL request to the LMF when the gNB gets involved in a positioning session and there is a requirement for data collection at the gNB for its AI/ML model. This can be decided based on gNB capability related to AI/ML model for positioning scenario 3a as previously indicated in table 2. On contrast, the LMF can initiate a query to the gNB involved with the positioning session whether the gNB requires the GTL for the AI/ML model training. The LMF can raise this query either during an active positioning session or after the positioning session is concluded/location estimate is computed. The LMF can also send the GTL in an unsolicited manner to the gNB after the location computing is done. The LMF-initiated approach is under the assumption that the LMF is aware of the AI/ML capabilities of the involved gNB by either the way of configuration during the deployment or the capability exchange.

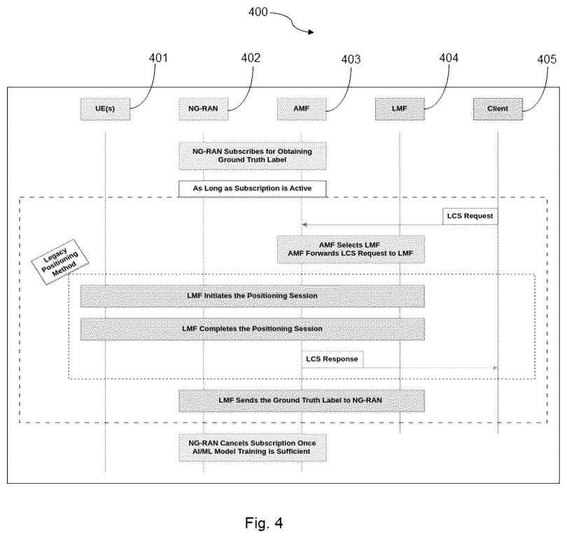

The explicit method 304 provides greater control for the gNB to train the AI/ML model so that the gNB can initiate a request for starting a positioning session based on the LCM state of the AI/ML model in the gNB. Since this approach is not tied to any ongoing positioning session, the LMF discovery and the selection must be performed by the AMF. The gNB can provide a list of suitable UE(s) for which the GTL is required. But there is no guarantee that the UE(s) in the list may provide consent for the data collection. The gNB can alternatively let the AMF decide the list of UE(s). Here, the AMF seeks the consent of the UE(s) and only chooses the ones that allow the data collection. The gNB can initiate the request for the GTL/positioning session either using the NGAP message 304a or the new radio positioning protocol Annex (NRPPa) protocol data unit (PDU) message 304b. The signaling flows for both implicit and explicit methods to get the GTL are explained in FIGS. 4-12 in the forthcoming paragraphs.

FIG. 4 illustrates a subscription-based implicit method 400 for obtaining GTL from the LMF in accordance with an embodiment of the present disclosure. FIG. 4 particularly shows the signaling mechanism for the subscription-based implicit method to get the GTL. The subscription-based method is an implicit approach where the cell tower (gNB) sets up a long-term agreement with the network to receive location data automatically. This allows the gNB to gather the GTLs it needs for AI training without having to start new positioning sessions itself. The NG-RAN/gNB subscribes to the AMF to obtain the GTL. The AMF activates the service and whenever a valid LCS request reaches the AMF which is for a UE connected to the subscribed NG-RAN, the AMF finds an appropriate LMF and instructs the LMF to send the location results of the UE to the NG-RAN upon completing the estimation. This process continues as long as the subscription is active. Location of the UE estimated using any available technique in the LMF. If the location is stored in the core network or known to LMF, then it is fetched by LMF to provide it to the NG-RAN.

The Subscription-Based GTL Update Method as illustrated in FIG. 4 represents a proactive approach to data collection where the NG-RAN establishes a persistent reporting relationship with the core network, rather than requesting data on an ad-hoc basis. This method is particularly efficient for long-term AI/ML model training where a continuous stream of high-accuracy location data is required.

The process begins with a formal handshake between the radio access network and the core network: The NG-RAN (gNB) 402 initiates the process by sending a subscription request to the AMF 403. This request indicates that the gNB wishes to receive GTL updates for AI/ML training purposes.

The AMF processes the request and activates the service for that specific gNB. This creates a state in the AMF where it is now “listening” for specific triggers related to UEs 401 served by that gNB. Once the subscription is active, the data flow is automated based on network events. The process is triggered whenever a valid LCS request arrives at the AMF for any UE 401 currently connected to the subscribing gNB.

Upon receiving the LCS request, the AMF selects an appropriate LMF 404. Crucially, the AMF instructs the LMF to deliver the final location results directly to the gNB immediately upon completion of the estimation. The LMF 404 determines the UE's location 401 using available positioning techniques. If a valid location is already stored or known within the core network, the LMF may simply fetch the existing data to save network resources.

Once the location (the GTL) is finalized, the LMF transfers it directly to the gNB. This bypasses the need for the gNB to “ask” for each individual update. The subscription is not permanent and can be ended through two distinct mechanisms i.e. In the first mechanism, the gNB monitors its own AI/ML training progress. Once it has collected sufficient data and the model performance is satisfactory, it sends a cancellation request to the AMF to stop the updates. In the second mechanism, the AMF or LMF may unilaterally terminate the subscription. This typically occurs if the network can no longer support the GTL transfer due to congestion, or based on specific network policies.

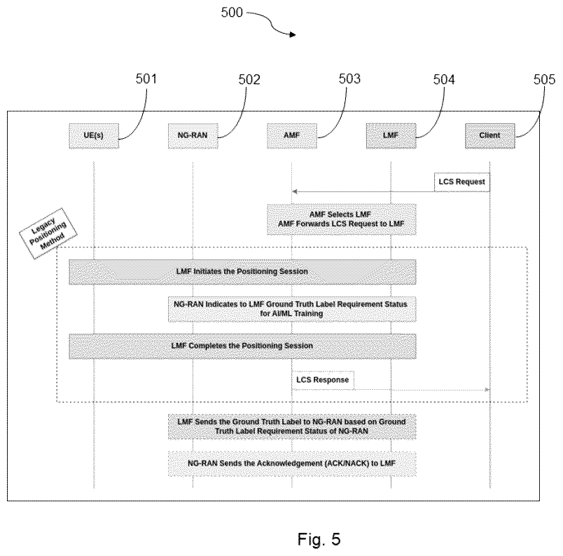

FIG. 5 illustrates a NG-RAN-initiated runtime-based implicit method 500 for obtaining the GTL from the LMF 504 in accordance with an embodiment of the present disclosure. FIG. 5 shows the signaling mechanism for the gNB/NG-RAN-initiated runtime-based implicit method to obtain the GTL. During an ongoing positioning session of a UE 501 involving the NG-RAN 502 of interest, based on feedback from the AI/ML model monitoring unit (not shown in the figure) at the NG-RAN, the NG-RAN 502 can indicate to the LMF 504 the requirement for the GTL to train the AI/ML model. The LMF on completing the location estimate computation of the UE, sends the GTL information to the NG-RAN. The NG-RAN sends the acknowledgment to the LMF with a positive or negative response based on the GTL usage.

As shown in FIG. 5, the NG-RAN-initiated runtime-based implicit method is a dynamic data collection strategy where the gNB requests training data on-the-fly during an active positioning session. Unlike subscription-based or standalone request methods, this approach is implicit because it relies on an existing LCS request initiated by an external client 505.

The NG-RAN initiated method as shown in FIG. 5 is not primarily driven by the NG-RAN itself, but rather originates from an external Client. This process begins when the Client transmits a LCS Request to the AMF) Upon receiving this request, the AMF 503 identifies and selects an appropriate LMF 504 to facilitate the positioning procedure, subsequently forwarding the LCS Request to that selected node.

Following the successful routing of the request, a standard positioning session is established between the LMF, the target UE 501, and the NG-RAN. The network now begins calculating the device's coordinates through conventional protocols. The unique implicit nature of this method occurs while the positioning session is still active, as the NG-RAN continuously monitors the performance and data needs of its internal AI/ML model. If the gNB evaluates its status and determines that supplemental training data is required, it intervenes in the ongoing session by evaluating its internal requirements during runtime. The NG-RAN then sends a specific message to the LMF regarding the “Ground Truth Label Requirement Status for AI/ML Training,” which functions as a dynamic flag instructing the LMF to provide the final location results to the gNB as well.

As the LMF concludes the location estimation process, the session reaches a dual-purpose completion phase. First, the LMF provides the estimated location back to the AMF, which then routes the standard LCS Response to the original external Client 505. Simultaneously, based on the requirement status flag received earlier in the session, the LMF delivers the GTL directly to the NG-RAN for its specific training purposes.

The final step in the sequence involves a feedback loop to ensure data integrity for the AI/ML training process. The NG-RAN transmits an Acknowledgement (ACK/NACK) back to the LMF. This communication confirms the successful receipt of the GTL and validates whether the data is suitable for inclusion in the gNB's training dataset.

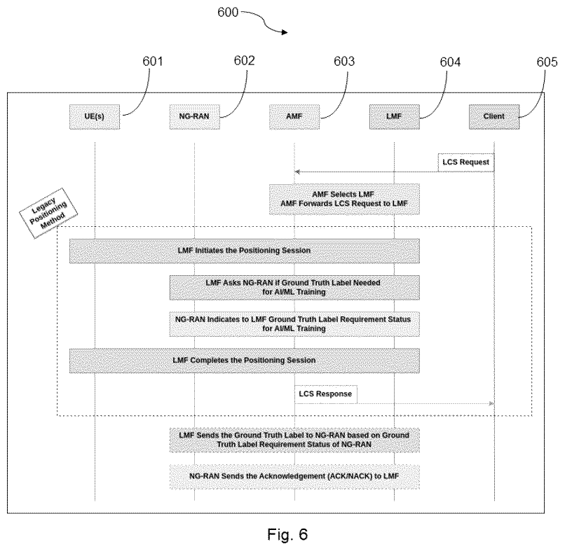

FIG. 6 illustrates an LMF-initiated runtime-based implicit method 600 requesting the NG-RAN 602 for the GTL Requirement during an active positioning session in accordance with an embodiment of the present disclosure. In the LMF 604 initiated runtime-based implicit method, the core network proactively manages data collection for AI/ML training by leveraging its knowledge of the NG-RAN's capabilities. This approach allows for efficient data delivery by integrating the training data request directly into active or concluding positioning sessions.

The process is initiated by an external Client 605 rather than the network infrastructure itself. This begins when the Client transmits a LCS Request to the AMF 603. The AMF then selects a suitable LMF and forwards the request to it, triggering the start of a Legacy Positioning Method involving the target UE 601 and the NG-RAN.

While the positioning session is ongoing, the LMF takes a proactive role based on its knowledge of the AI/ML capabilities of the NG-RAN. As shown in FIG. 6, the LMF intervenes during the active session by sending an inquiry to the NG-RAN using an existing NRPPa message to ask if the GTL is needed for AI/ML training.

In response to the LMF's inquiry, the NG-RAN evaluates its internal monitoring and provides a “Ground Truth Label Requirement Status”. This status indicates to the LMF whether the current data is necessary for the NG-RAN's specific training requirements.

The final phase occurs as the LMF completes the location computation for the UE. The LMF provides the standard location information to the AMF, which sends the LCS Response back to the original Client. Simultaneously, if the NG-RAN's previously indicated status was positive, the LMF delivers the GTL directly to the NG-RAN. The NG-RAN now sends an Acknowledgement (ACK/NACK) to the LMF, providing a positive or negative response based on the successful reception and utility of the GTL.

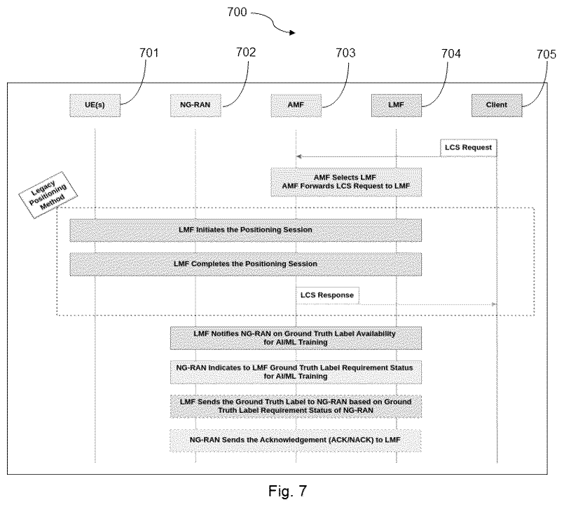

FIG. 7 illustrates a LMF-initiated runtime-based implicit method 700 requesting the NG-RAN 702 for the GTL requirement after an active positioning session according to an embodiment of the present disclosure. The LMF-initiated post-session implicit method as shown in FIG. 7 describes a scenario where the core network offers training data to the radio access network immediately following the conclusion of a standard positioning event. This ensures that the NG-RAN can obtain high-quality ground truth data without interfering with the active runtime of the positioning session.

The process is initially triggered by an external Client 705 sending a LCS Request to the AMF 703, which then selects an appropriate LMF 704 and forwards the request to begin the positioning procedure. A standard Legacy Positioning Method is then executed between the LMF, the target UE(s) 701, and the NG-RAN. As shown in FIG. 7, The LMF completes the positioning session and the standard LCS Response is sent back to the Client via the AMF.

Once the location computation is finished, the LMF proactively notifies the NG-RAN about the availability of the GTL for AI/ML training. According to the disclosure, this notification is transmitted using a new NRPPa message. Upon receiving the notification, the NG-RAN evaluates its internal training needs and indicates its GTL Requirement Status back to the LMF. Based on the status provided by the NG-RAN, the LMF makes a final decision on whether to transmit the data. If required, the LMF sends the GTL directly to the NG-RAN.

The NG-RAN sends an Acknowledgement (ACK/NACK) to the LMF, providing a positive or negative response based on the successful reception of the GTL.

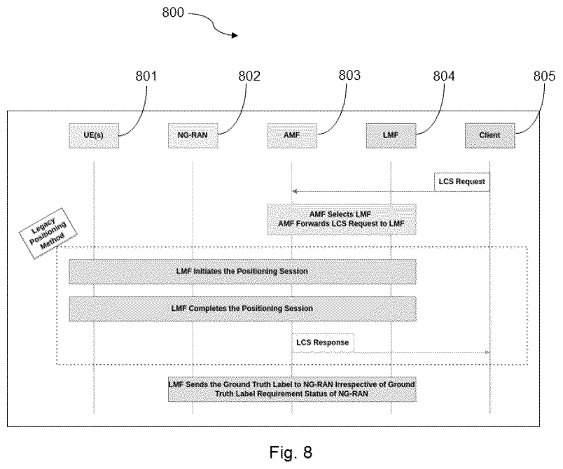

FIG. 8 illustrates a LMF-initiated runtime-based implicit method 800 to Send the GTL in an unsolicited manner to the NG-RAN 802 according to an embodiment of the present disclosure. The LMF-initiated unsolicited method as shown in FIG. 8 represents an automated delivery approach where the core network provides training data to the radio access network without a specific request or requirement check. In this scenario, the LMF 804 acts as a continuous data provider, ensuring the NG-RAN 802 has constant access to GTLs for all relevant positioning events.

The process is triggered externally when a client 805 submits a LCS Request to the AMF 803. The AMF 803 performs its standard role of selecting a suitable LMF and forwarding the request to initiate the positioning session. A Legacy Positioning Method is then conducted, involving the LMF, the target UE(s) 801, and the NG-RAN.

Following the completion of the location computation, the LMF provides the location information to the AMF, which then transmits the final LCS Response to the requesting Client. Immediately after the location computation for a UE connected to the NG-RAN is complete, the LMF sends the GTL to the NG-RAN in an unsolicited manner.

The LMF maintains this automated behavior, sending the GTL whenever a new LCS request is processed for any UE connected to that specific NG-RAN. Unlike the methods shown in FIGS. 6 and 7, this transfer occurs irrespective of the Ground Truth Label Requirement Status of the NG-RAN. Once the GTL is received, it is entirely up to the NG-RAN to decide whether to utilize the data for its internal AI/ML model training or to discard it. Thus, The LMF keeps sending the GTL whenever there is an LCS request for any UE connected to the NG-RAN. It is up to the NG-RAN whether to use the GTL for its AI/ML model training.

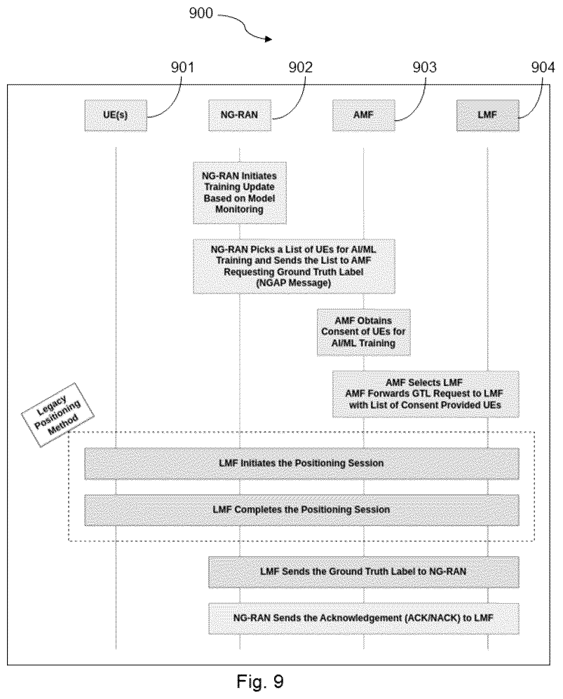

FIG. 9 illustrates an explicit method 900 to obtain the GTL from the LMF 904 using the NGAP message containing list of UE(s) 901 in accordance with an embodiment of the present disclosure. If the NG-RAN 902 desires to train the AI/ML model without depending on the occurrence of a LCS request coming to the AMF/LMF for a UE 901 connected with the NG-RAN, the NG-RAN can initiate a positioning session to obtain the GTL from the LMF 904 as shown in FIGS. 9, 10, 11, and 12. This can be done using the NGAP message or the NRPPa PDU.

The NG-RAN can share a list of preferred UE(s) associated with it as candidates for data collection as part of the GTL request message. If the list of UE(s) is not provided by the NG-RAN, the AMF 903 can find a suitable list and proceed with the GTL request. The AMF 903 selects an appropriate LMF and forwards the GTL request with the list of UE(s). If the NG-RAN uses the NRPPa PDU for the GTL request, the AMF cannot decode the contents of the PDU. Therefore, the AMF proceeds with the discovery and selection of the LMF. The LMF can decide to initiate the positioning session for the list of UE(s) provided by the AMF or send the positioning reference unit (PRU) information if available, or both. The LMF separately sends the corresponding GTL to the NG-RAN after the location computation of each of the UE(s) in the list.

As shown in FIG. 9, the NG-RAN decides to send a request for the GTL based on the training update instruction from the AI/ML model monitoring unit. The NG-RAN chooses a list of UE(s) associated with it and sends it along with the GTL request to the AMF in an NGAP message. The AMF confirms the consent from the list of UE(s) shared by the NG-RAN, selects a suitable LMF, and forwards the GTL request along with the list of UE(s) that provided the consent for the data collection. The LMF starts the positioning sessions for the list of the UE(s) and after estimating the locations, sends the GTL of each of the UE(s) separately to the NG-RAN. The NG-RAN acknowledges the receipt of the GTL for each of the UE(s) to the LMF.

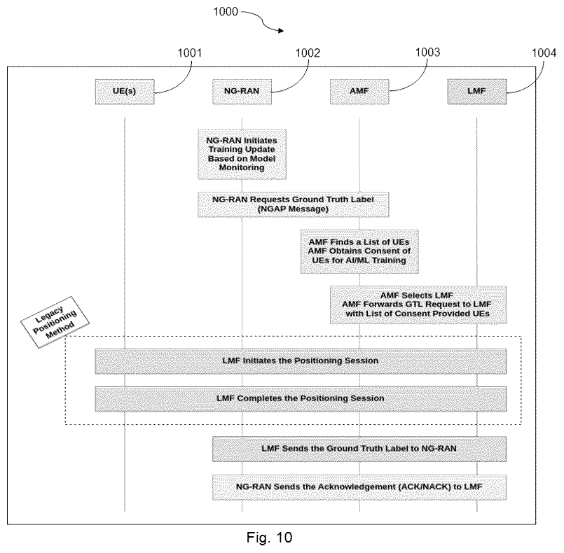

FIG. 10 illustrates an explicit method 1000 to obtain the GTL from the LMF 1004 using the NGAP message without list of UE(s) in accordance with an embodiment of the present disclosure. In the NG-RAN-initiated runtime-based method shown in FIG. 10, the radio access network delegates the identification of target devices to the core network to facilitate AI/ML training. This signaling flow allows the NG-RAN 1002 to obtain ground truth data without maintaining its own database of user consent or device availability.

As shown in FIG. 10, the process begins within the NG-RAN 1002, which monitors the performance of its AI/ML models. Based on this model monitoring, the NG-RAN decides to initiate a training update and generates a request for a GTL. This request is transmitted to the AMF 1003 via an NGAP message. Notably, in this embodiment, the NG-RAN does not provide a specific list of target devices but instead lets the AMF choose the appropriate UEs associated with that NG-RAN node.

Upon receiving the NGAP message, the AMF 1003 performs UE discovery and consent verification. The AMF finds a suitable list of UEs that are currently associated with the requesting NG-RAN. For those identified UEs, the AMF obtains or confirms data collection consent specifically for AI/ML training purposes.

Once a list of consent-provided UEs is established, the AMF selects a suitable LMF and forwards the GTL request along with the finalized list of UEs. The LMF 1004 then initiates a legacy positioning session for each UE on the provided list. After completing the positioning session and estimating the locations for the identified UEs, the LMF sends the Ground Truth Label for each device separately back to the NG-RAN. The signaling flow concludes with the NG-RAN transmitting an Acknowledgement (ACK/NACK) to the LMF for each received GTL to confirm successful delivery and data suitability.

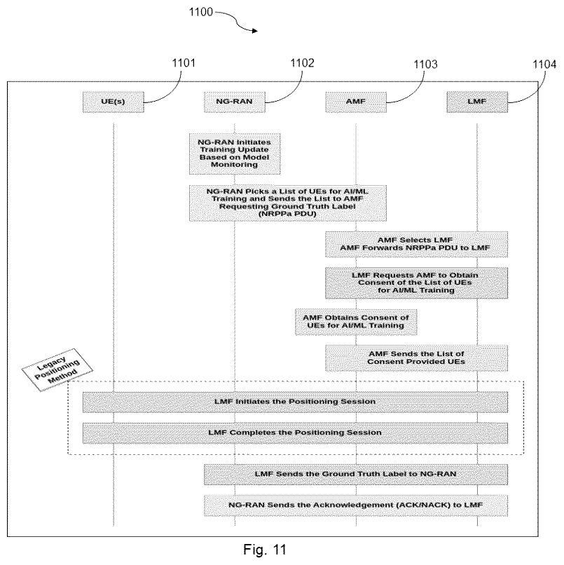

FIG. 11 illustrates an explicit method 1100 to obtain the GTL from the LMF 1104 using the NRPPa PDU containing list of UE(s) in accordance with an embodiment of the present disclosure. In the NG-RAN-initiated runtime-based method illustrated in FIG. 11, the radio access network utilizes the NRPPa to request training data while the core network handles the multi-step consent verification process. This approach distinguishes itself by using a specific positioning protocol for the initial request and delegating the consent handshake to a coordination between the LMF 1104 and the AMF 1103.

As shown in FIG. 11, the NG-RAN 1102 decides to send a request for the GTL based on the training update instruction from the AI/ML model monitoring unit. The NG-RAN chooses a list of UE(s) 1101 associated with it and sends it along with the GTL request to the AMF 1103 in an NRPPa PDU. The AMF selects a suitable LMF and forwards the GTL request to the LMF. The LMF identifies the list of UE(s) and requests the AMF for consent of the UE(s) for the data collection. The AMF confirms the consent of UE(s) and sends the list of UE(s) to the LMF that provided the consent for the data collection. The LMF starts the positioning sessions for the list of the UE(s) and after estimating the locations, sends the GTL of each of the UE(s) separately to the NG-RAN. The NG-RAN acknowledges the receipt of the GTL for each of the UE(s) to the LMF.

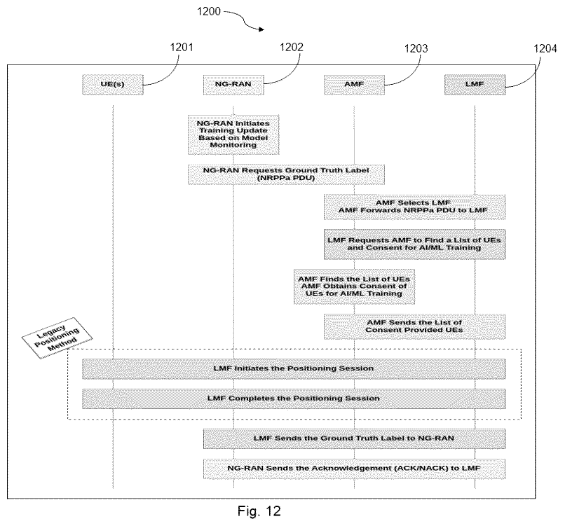

FIG. 12 illustrates an explicit method 1200 to obtain the GTL from the LMF 1204 using the NRPPa PDU without list of UE(s) in accordance with an embodiment of the present disclosure. The NG-RAN 1202 initiated runtime-based method utilizes a protocol-driven approach where the identification of target devices is delegated to core network functions.

The process is initiated by the NG-RAN, which monitors its internal AI/ML models and determines that a training update is necessary. Following this decision, the NG-RAN 1202 transmits a request for a GTL to the AMF 1203. This request is sent as a NRPPa PDU and, unlike other methods, does not specify a list of target UEs. The AMF 1203 receives this PDU, selects an appropriate LMF, and forwards the GTL request to it. Upon processing the request, the LMF 1204 must identify the target devices for the session; it therefore requests the AMF to find a list of UEs 1201 currently associated with that specific NG-RAN node. This request from the LMF also includes a requirement to verify the consent of those UEs for data collection intended for AI/ML training.

In response to the LMF's inquiry, the AMF identifies an appropriate list of UEs and confirms their data collection consent. The AMF then transmits this finalized list of consent-provided UEs back to the LMF. With the targets and permissions established, the LMF initiates and completes the necessary positioning sessions for the identified UEs.

After the LMF estimates the locations, it sends the GTL for each individual UE separately to the NG-RAN. The signaling flow concludes when the NG-RAN acknowledges the receipt of each GTL by sending an Acknowledgement (ACK/NACK) back to the LMF.

FIG. 13 is a flowchart illustrating a method 1300 for subscription-based GTL acquisition and AI/ML model training at an NG-RAN node in accordance with an embodiment of the present disclosure. The method for collecting GTL of UE by NG-RAN node to train and monitor AI/ML model used for UE positioning, comprises sending 1302, by the NG-RAN to an AMF, a subscription request to obtain a GTL associated with at least one UE connected to the NG-RAN node, obtaining 1304, by the NG-RAN, at least one radio signal measurement from a target UE during a positioning session associated with a LCS request, receiving 1306, by the NG-RAN, from a LMF, the GTL corresponding to the target UE based on the AMF indication to the LMF to share the GTL with the NG-RAN and training 1308, by the NG-RAN, the AI/ML model for UE positioning by using at least one of the GTL and at least one radio signal measurement.

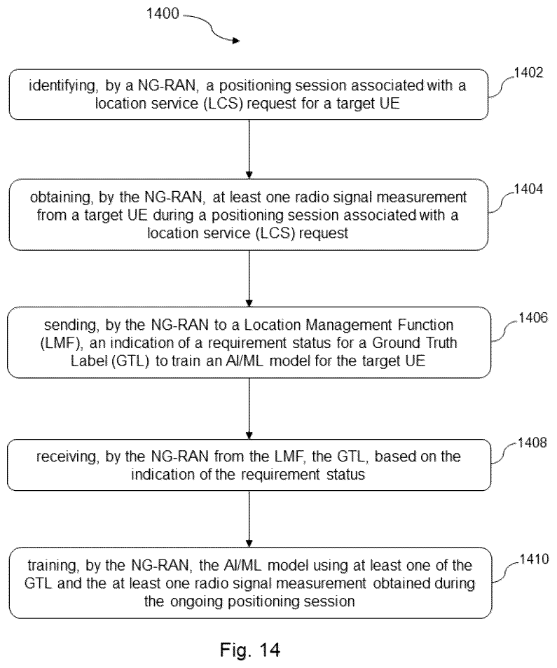

FIG. 14 is a flowchart illustrating a method 1400 for requirement-based GTL acquisition at an NG-RAN node during an ongoing positioning session in accordance with another embodiment of the present disclosure. The method for collecting GTL of UE by a NG-RAN node to train and monitor AI/ML model used for UE positioning, comprises identifying 1402, by a NG-RAN, a positioning session associated with a LCS request for a target UE, obtaining 1404, by the NG-RAN, at least one radio signal measurement from a target UE during a positioning session associated with a LCS request, sending 1406, by the NG-RAN to LMF, an indication of a requirement status for a GTL to train an AI/ML model for the target UE, receiving, 1408 by the NG-RAN from the LMF, the GTL, based on the indication of the requirement status and training 1410, by the NG-RAN, the AI/ML model using at least one of the GTL and the at least one radio signal measurement obtained during the ongoing positioning session.

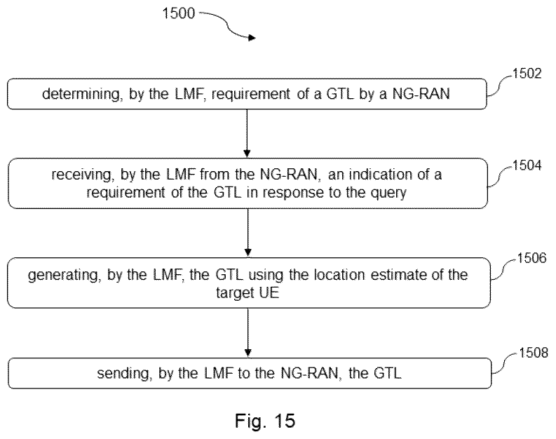

FIG. 15 is a flowchart illustrating a method 1500 for GTL requirement negotiation and delivery from the perspective of a LMF in accordance with another embodiment of the present disclosure. The method for sending GTL of UE by a LMF to a NG-RAN, comprises determining 1502, by the LMF, requirement of a GTL by a NG-RAN, receiving 1504, by the LMF from the NG-RAN, an indication of a requirement of the GTL in response to the query, generating 1506, by the LMF, the GTL using the location estimate of the target UE and sending, 1508 by the LMF to the NG-RAN, the GTL.

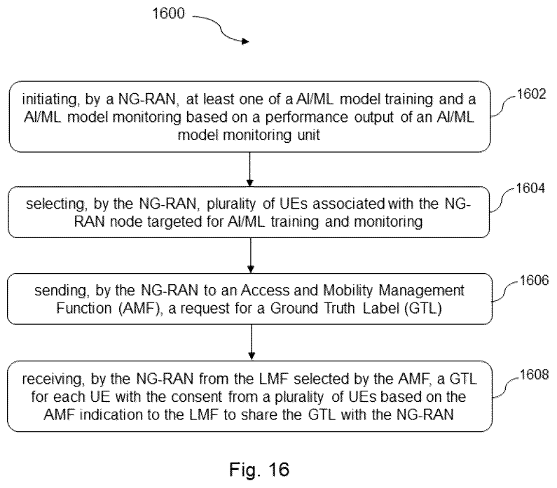

FIG. 16 is a flowchart illustrating a method 1600 for proactive AI/ML model training based on performance monitoring and user consent verification in accordance with another embodiment of the present disclosure. The method for collecting GTL of UE by NG-RAN node to train and monitor AI/ML model used for UE positioning, comprises initiating 1602, by a NG-RAN, at least one of a AI/ML model training and a AI/ML model monitoring based on a performance output of an AI/ML model monitoring unit, selecting 1604, by the NG-RAN, plurality of UEs associated with the NG-RAN node targeted for AI/ML training and monitoring, sending 1606, by the NG-RAN to an AMF, a request for a GTL, receiving 1608, by the NG-RAN from the LMF selected by the AMF, a GTL for each UE with the consent from a plurality of UEs based on the AMF indication to the LMF to share the GTL with the NG-RAN.

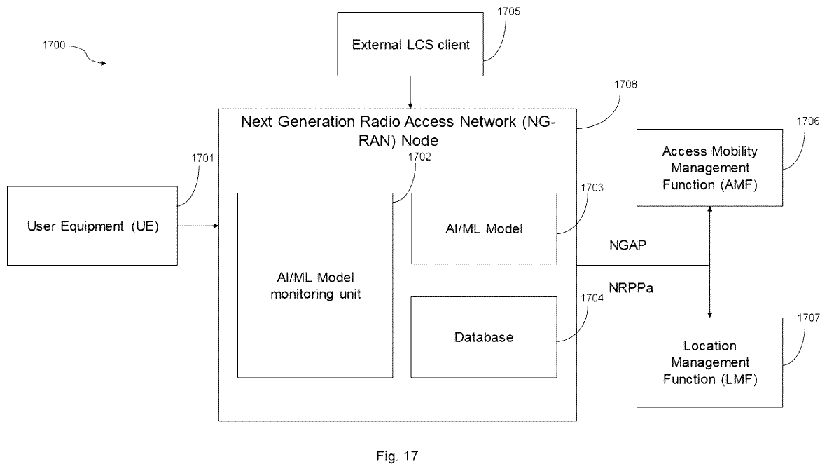

FIG. 17 illustrates an example communication system 1700 configured to implement AI/ML-assisted positioning methods described in the present disclosure. FIG. 17 particularly illustrates a communication system architecture configured to implement AI/ML-assisted positioning methods as shown in FIGS. 3 to 12 of this disclosure. The system comprises a target UE 1701, a NG-RAN node 1708, an AMF 1706, and a LMF 1707. These entities interact through defined interfaces, mot limiting to, NGAP, and NRPPa, to provide a hardware and software framework for model training and inference.

The NG-RAN node 1708 (e.g., a gNB) serves as the primary apparatus for executing the AI/ML positioning logic. As shown in FIG. 17, the NG-RAN node 1708 integrates several functional units namely, the AI/ML Model 1703, AI/ML model monitoring unit 1702 and the database 1704. The AI/ML model as shown in FIG. 17 is a machine learning architecture configured to predict UE 1701 location coordinates or signal characteristics based on radio inputs. AI/ML model monitoring unit is for example, a performance-tracking entity that monitors the inference accuracy of the AI/ML model. This unit acts as a trigger for initiating training updates when accuracy falls below a threshold. The database show in the figure is a local database or a cloud-based database used to collect and pair “Radio Signal Measurements” with their corresponding GTLs.

In an embodiment, the NG-RAN node 1708 transmits a GTL Subscription Request to the AMF 1706 to establish a long-term agreement for receiving training labels. This interaction enables the automated delivery of GTLs for positioning sessions associated with a specific UE without requiring repetitive per-session requests.

In another embodiment, the LMF 1707 is configured to transmit a Query to the NG-RAN node 1708 to determine if a GTL is required for an ongoing session. The NG-RAN node evaluates its internal training state and responds with an Indication of a Requirement Status. This ensures that high-accuracy GTLs are only generated and delivered when the local AI/ML model necessitates a training update, optimizing network resource utilization.

In another embodiment, the NG-RAN node 1708 transmits a list of target UEs to the AMF. The AMF performs the critical function of verifying or obtaining User Consent for data collection for those specific UEs. This provides the legal and technical gateway required before the system proceeds with generating training data.

The Database stores pairs of radio measurements from the UE and GTLs delivered by the LMF (facilitated via the NRPPa path). Upon successful reception of a GTL, the NG-RAN node transmits an ACK/NACK signal to the LMF to confirm data integrity. Once the Database 1704 reaches a pre-defined training threshold, the AI/ML Model executes a training update using the paired datasets to refine its positioning accuracy.

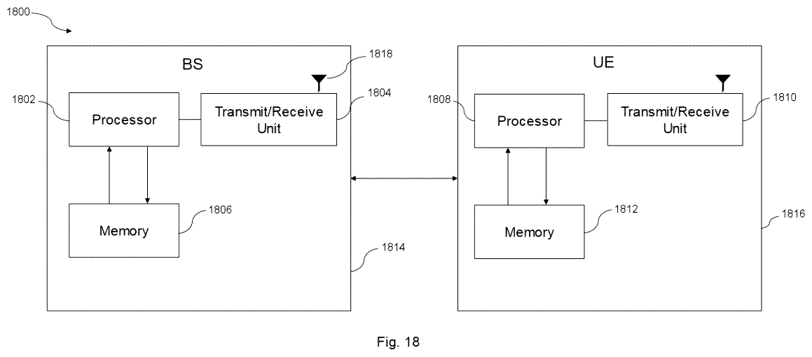

FIG. 18 is an example wireless communication system 1800 configured to perform the methods described in FIGS. 4-16 of the present disclosure. The base station (BS) 1814 comprises a processor 1802, a transmit/receive unit 1804 coupled to one or more antennas, and a memory 1806. The memory 1806 may store instructions that, when executed by the processor 1802, cause the BS 1814 to perform its designated functions. The transmit/receive unit 1804 is configured to transmit downlink signals, and receive uplink signals from the UE.

The UE 1816 comprises a processor 1808, a transmit/receive unit 1810 coupled to one or more antennas, and a memory 1812. The memory 1812 may store instructions that, when executed by the processor 1808, cause the UE 1816 to perform all the UE-side steps of the methods described herein. In various embodiments of the present disclosure, the components of the system 1800 are configured to operate in conjunction to perform the methods for UE positioning. Specifically, in an embodiment, the processor 1808 of the UE 1816 is configured to send, by the NG-RAN to an AMF, a subscription request to obtain a GTL associated with at least one UE connected to the NG-RAN node, obtain, by the NG-RAN, at least one radio signal measurement from a target UE during a positioning session associated with a LCS request, receive, by the NG-RAN, from a LMF, the GTL corresponding to the target UE based on the AMF indication to the LMF to share the GTL with the NG-RAN and train, by the NG-RAN, the AI/ML model for UE positioning by using at least one of the GTL and at least one radio signal measurement.

In another embodiment, the processor 1808 of the UE 1816 is configured to identify, by a NG-RAN, a positioning session associated with a LCS request for a target UE, obtain, by the NG-RAN, at least one radio signal measurement from a target UE during a positioning session associated with a LCS request, send, by the NG-RAN to a LMF, an indication of a requirement status for a GTL to train an AI/ML model for the target UE, receive, by the NG-RAN from the LMF, the GTL, based on the indication of the requirement status and train, by the NG-RAN, the AI/ML model using at least one of the GTL and the at least one radio signal measurement obtained during the ongoing positioning session.

In another embodiment, the processor 1808 of the UE 1816 is configured to determine, by the LMF, requirement of a GTL by a NG-RAN, receive, by the LMF from the NG-RAN, an indication of a requirement of the GTL in response to the query, generate, by the LMF, the GTL using the location estimate of the target UE; and send, by the LMF to the NG-RAN, the GTL.

In yet another embodiment, the processor 1808 of the UE 1816 is configured to initiate, by a NG-RAN, at least one of a AI/ML model training and a AI/ML model monitoring based on a performance output of an AI/ML model monitoring unit, select, by the NG-RAN, plurality of UEs associated with the NG-RAN node targeted for AI/ML training and monitoring, send, by the NG-RAN to an AMF, a request for a GTL, receive, by the NG-RAN from the LMF selected by the AMF, a GTL for each UE with the consent from a plurality of UEs based on the AMF indication to the LMF to share the GTL with the NG-RAN.

The figures of the disclosure are provided to illustrate some examples of the invention described. The figures are not to limit the scope of the depicted embodiments or the appended claims.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Embodiments of the present disclosure may be implemented as computer program products that comprise articles of manufacture. Such computer program products may include one or more software components including, for example, applications, software objects, methods, data structure, and/or the like. In some embodiments, a software component may be stored on one or more non-transitory computer-readable media, which computer program product may comprise the computer-readable media with software component, comprising computer executable instructions, included thereon. The various control and operational systems described herein may incorporate one or more of such computer program products and/or software components for causing the various components/modules thereof to operate in accordance with the functionalities described herein.

A software component may be coded in any of a variety of programming languages. An illustrative programming language may be a lower-level programming language such as an assembly language associated with a particular hardware architecture and/or operating system platform/system. Other example of programming languages included, but are not limited to, a macro language, a shell or command language, a job control language, a script language, a database query, or search language, and/or report writing language. In one or more example embodiments, a software component comprising instructions in one of the foregoing examples of programming languages may be executed directly by an operating system or other software component without having to be first transformed into another form. A software component may be stored as a file or other data storage methods. Software components of a similar type or functionally related may be stored together such as, for example, in a particular directory, folder, or repository. Software components may be static (e.g., pre-established, or fixed) or dynamic (e.g., created or modified at the time of execution).

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub combination. Moreover, although features may be described above as acting in certain combinations and even initially claimed as such, one or more features from a claimed combination can in some cases be excised from the combination, and the claimed combination may be directed to a sub combination or variation of a sub combination.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

We claim:

1. (canceled)

2. (canceled)

3. (canceled)

4. (canceled)

5. (canceled)

6. (canceled)

7. (canceled)

8. (canceled)

9. (canceled)

10. A method for collecting ground truth label (GTL) of User Equipment (UE) by a next generation radio access network (NG-RAN) node to train and monitor AI/ML model used for UE positioning, the method comprising:
identifying, by a NG-RAN, a positioning session associated with a location service (LCS) request for a target UE;
obtaining, by the NG-RAN, at least one radio signal measurement from a target UE during a positioning session associated with a location service (LCS) request;
sending, by the NG-RAN to a Location Management Function (LMF), an indication of a requirement status for a Ground Truth Label (GTL) to train an AI/ML model for the target UE;
receiving, by the NG-RAN from the LMF, the GTL, based on the indication of the requirement status; and
training, by the NG-RAN, the AI/ML model using at least one of the GTL and the at least one radio signal measurement obtained during the ongoing positioning session.

11. The method of claim 10, receiving by the NG-RAN from the LMF further comprises transmitting, by the NG-RAN to the LMF, an acknowledgement (ACK/NACK) in response to receiving the GTL.

12. The method of claim 10, wherein the GTL is received from the LMF using a New Radio Positioning Protocol A (NRPPa) Protocol Data Unit (PDU), where the GTL consists of at least one of location of the UE, relative location of the UE, angle of arrival, carries phase of the signal, time of arrival and time difference of arrival.

13. The method of claim 10, wherein sending an indication of a requirement status is based on an indication from AI/ML model monitoring unit at the NG-RAN node.

14. A method for sending ground truth label (GTL) of User Equipment (UE) by a location management function (LMF) to a next generation radio access network (NG-RAN), the method comprising:
determining, by the LMF, requirement of a GTL by a NG-RAN;
receiving, by the LMF from the NG-RAN, an indication of a requirement of the GTL in response to the query;
generating, by the LMF, the GTL using the location estimate of the target UE; and
sending, by the LMF to the NG-RAN, the GTL.

15. The method of claim 14, receiving by the NG-RAN from the LMF further comprises transmitting, by the NG-RAN, an acknowledgement (ACK/NACK) indicating a positive or negative response based on a reception of the GTL.

16. The method of claim 14, determining by the LMF further comprises:
sending, by the LMF to the NG-RAN during the positioning session of a target UE, a query using a New Radio Positioning Protocol A (NRPPa) message related to the GTL for AI/ML training;

17. The method of claim 14, wherein the query is sent after the completion of the positioning session.

18. The method of claim 15, wherein sending the query further comprises notifying the NG-RAN node of an availability of the GTL for the AI/ML training using a New Radio Positioning Protocol A (NRPPa) message.

19. A method for collecting ground truth label (GTL) of User Equipment (UE) by next generation radio access network (NG-RAN) node to train and monitor AI/ML model used for UE positioning, the method comprising:
initiating, by a NG-RAN, at least one of a AI/ML model training and a AI/ML model monitoring based on a performance output of an AI/ML model monitoring unit;
selecting, by the NG-RAN, plurality of UEs associated with the NG-RAN node targeted for AI/ML training and monitoring;
sending, by the NG-RAN to an Access and Mobility Management Function (AMF), a request for a Ground Truth Label (GTL);
receiving, by the NG-RAN from the LMF selected by the AMF, a GTL for each UE with the consent from a plurality of UEs based on the AMF indication to the LMF to share the GTL with the NG-RAN.

20. The method of claim 19, receiving by the NG-RAN from the LMF further comprises transmitting, by the NG-RAN, an acknowledgement (ACK/NACK) indicating a positive or negative response based on a reception of the GTL.

21. The method of claim 19, wherein the plurality of UEs is one of;
selected by the AMF; or
provided in the request for the GTL by the NG-RAN.

22. The method of claim 19, wherein the performance output is determined based on a metric of the AI/ML model falling below a threshold.

23. The method of claim 19, wherein the request for the GTL is sent to the AMF using one of New Radio Positioning Protocol A (NRPPa) Protocol Data Unit (PDU) or next generation application protocol (NGAP) message.

24. The method of claim 23, wherein the request for the GTL sent to the AMF is forwarded to the LMF.

25. The method of claim 24, wherein the LMF requests the AMF to identify one or more UEs with consent associated with the NG-RAN node.

26. The method of claims 21 through 24, wherein the plurality of UEs in the request for GTL received by LMF is forwarded to AMF to initiate a consent request.

27. The method of claim 26, wherein the AMF provides the one or more UEs with consent from the plurality of UEs, to the LMF.

28. The method of claim 21, wherein the AMF identifies one or more UEs with consent for GTL from the plurality of UE selected and forward to the LMF.

29. The method of claim 23, wherein the NRPPa PDU is sent in a Next Generation Application Protocol (NGAP) message.

30. The method of claim 19, wherein the request is configured to cause the selected LMF to initiate a consent request to the AMF for the plurality of the UEs.

31. An apparatus for User Equipment (UE) positioning, the apparatus comprising:
a processor;
a memory storing program instructions which, when executed by the processor, causes the processor to:
send, by the NG-RAN to an Access and Mobility Management Function (AMF), a subscription request to obtain a Ground Truth Label (GTL) associated with at least one UE connected to the NG-RAN node;
obtain, by the NG-RAN, at least one radio signal measurement from a target UE during a positioning session associated with a location service (LCS) request;
receive, by the NG-RAN, from a location management function (LMF), the GTL corresponding to the target UE based on the AMF indication to the LMF to share the GTL with the NG-RAN; and
train, by the NG-RAN, the AI/ML model for UE positioning by using at least one of the GTL and at least one radio signal measurement.

32. An apparatus for User Equipment (UE) positioning, the apparatus comprising:
a processor;
a memory storing program instructions which, when executed by the processor, causes the processor to:
identify, by a NG-RAN, a positioning session associated with a location service (LCS) request for a target UE;
obtain, by the NG-RAN, at least one radio signal measurement from a target UE during a positioning session associated with a location service (LCS) request;
send, by the NG-RAN to a Location Management Function (LMF), an indication of a requirement status for a Ground Truth Label (GTL) to train an AI/ML model for the target UE;
receive, by the NG-RAN from the LMF, the GTL, based on the indication of the requirement status; and
train, by the NG-RAN, the AI/ML model using at least one of the GTL and the at least one radio signal measurement obtained during the ongoing positioning session.

33. An apparatus for User Equipment (UE) positioning, the apparatus comprising:
a processor;
a memory storing program instructions which, when executed by the processor, causes the processor to:
determine, by the LMF, requirement of a GTL by a NG-RAN;
receive, by the LMF from the NG-RAN, an indication of a requirement of the GTL in response to the query;
generate, by the LMF, the GTL using the location estimate of the target UE; and
send, by the LMF to the NG-RAN, the GTL.

34. An apparatus for User Equipment (UE) positioning, the apparatus comprising:
a processor;
a memory storing program instructions which, when executed by the processor, causes the processor to:
initiate, by a NG-RAN, at least one of a AI/ML model training and a AI/ML model monitoring based on a performance output of an AI/ML model monitoring unit;
select, by the NG-RAN, plurality of UEs associated with the NG-RAN node targeted for AI/ML training and monitoring;
send, by the NG-RAN to an Access and Mobility Management Function (AMF), a request for a Ground Truth Label (GTL);
receive, by the NG-RAN from the LMF selected by the AMF, a GTL for each UE with the consent from a plurality of UEs based on the AMF indication to the LMF to share the GTL with the NG-RAN.
